(19) United States
(12) Patent Application Publication
(10) Pub. No.: US 2018/0192031 A1
(43) Pub. Date: Jul. 5, 2018

(54) Virtual Reality Viewing System

(71) Applicant: Leslie C. Hardison, Cape Coral, FL (US)

(72) Inventor: Leslie C. Hardison, Cape Coral, FL (US)

(21) Appl. No.: 15/617,029

(22) Filed: Jun. 8, 2017

Related U.S. Application Data
(60) Provisional application No. 62/441,760, filed on Jan. 3, 2017.

(51) Int. Cl. H04N 13/02; H04N 13/00; H04N 13/04; H04N 5/91; H04N 9/87

(52) U.S. Cl. CPC H04N 13/0239; H04N 13/0055; H04N 13/0296; H04N 13/044; H04N 2213/008; H04N 5/91; H04N 9/87; H04N 2213/001; H04N 13/0497

(57) ABSTRACT

A virtual reality system composed of a virtual reality box, the virtual reality box mounting a smart phone or containing a similar computing device that is in a fixed position relative to a user's eyes. The smart phone or computer including one or more processors and a memory, and having front and a back. The front including a touch screen display, the back including a first camera lens and a second camera lens spaced apart from the first camera lens, and electronic sensing devices which measure the azimuth and elevation angle of the centerline of the camera located in the computing device in communication with the one or more processors and memory and receiving both visual and orientational information that is passed through the first and second camera lenses.

This application claims the benefit of provisional application No. 62441760 file 3 Jan. 2017.

### FIELD OF THE INVENTION

The present invention generally relates to an adaptation to a smart phone, or similar multifunctional device but without the voice communication features of the “smartphone”, to provide an integrated camera & virtual reality box system.

### BACKGROUND

The system utilizes various components to provide a user with an integrated camera and virtual reality (VR) box system that allows the user to record true three dimensional (3D) photographs and videos. In addition the user can immediately, if desired, play back these recordings while wearing the apparatus to experience the photos/videos in 3D, or can play and/or view previously recorded videos and photographs.

Current smart phone technology has been adapted by certain developers to record videos, take pictures, and display various forms of video to a user. For instance the following devices have become known in the art.

U.S. Pat. No. 8,762,852 to Davis et al describes methods and arrangements involving portable devices, such as smartphones and tablet computers, are disclosed. One arrangement enables a creator of content to select software with which that creator's content should be rendered—assuring continuity between artistic intention and delivery. Another arrangement utilizes the camera of a smartphone to identify nearby subjects, and take actions based thereon. Others rely on near field chip (RFID) identification of objects, or on identification of audio streams (e.g., music, voice). Some of the detailed technologies concern improvements to the user interfaces associated with such devices. Others involve use of these devices in connection with shopping, text entry, sign language interpretation, and vision-based discovery. Still other improvements are architectural in nature, e.g., relating to evidence-based state machines, and blackboard systems. Yet other technologies concern use of linked data in portable devices—some of which exploit GPU capabilities. Still other technologies concern computational photography. A great variety of other features and arrangements are also detailed.

U.S. Pat. No. 9,035,905 to Saukko et. al describes an apparatus, the apparatus comprising at least one processor, and at least one memory including computer program code, the at least one memory and the computer program code configured, with the at least one processor, to cause the apparatus to perform at least the following: use a determined user's grip of a portable electronic device as a user input to the portable electronic device to control data streaming functionality provided using the portable electronic device.

U.S. Pat. No. 9,462,210 to Dagit describes a software application and system that enables point-and-click interaction with a TV screen. The application determines geocode positioning information for a handheld device, and uses that data to create a virtual pointer for a television display or interactive device. Some embodiments utilize motion sensing and touchscreen input for gesture recognition interacting with video content or interactive device. Motion sensing can be coupled with positioning or localization techniques the user to calibrate the location of the interactive devices and the user location to establish and maintain virtual pointer connection relationships. The system may utilize wireless network infrastructure and cloud-based calculation and storage of position and orientation values to enable the handheld device in the TV viewing area to replace or surpass the functionality of the traditional TV remote control, and also interface directly with visual feedback on the TV screen.

US PGPUB No. 2011/0162002 by Jones et al, describes various systems and methods are disclosed for providing an interactive viewing experience. Viewers of a video program, a motion picture, or a live action broadcast may access information regarding products displayed in the video program, motion picture or live action broadcast, and, if desired, enter transactions to purchase the featured products that are displayed in the video program, motion picture or live action broadcast. The video program, motion picture, or live action broadcast is presented to viewers on a primary interface device such as a television, a video display monitor, a computer display, a projector projecting moving images onto a screen, or any other display device capable of receiving and displaying moving images. The featured products are purposefully placed in the various scenes of the video program motion picture, or live action broadcast so that they are prominently displayed when the video program, motion picture or live action broadcast presented to one or more viewers. A secondary interface presents information about the featured products as the featured products appear during the presentation of the video program, motion picture, or live action broadcast. The secondary interface further provides a mechanism by which viewers may purchase the featured products via the secondary interface.

### BRIEF SUMMARY

Smart phones and small tablet devices are ubiquitous in modern society. Many are currently developed, manufactured, and sold by a number of major manufacturers, some of which have developed standard sizes and means of adapting them. Thus, the current application contemplates a modification to a modern smart phone comprising at least three distinct components: two camera lenses arranged for taking simultaneous pairs of 3D images, a software application package (AP) to manage taking two simultaneous still photographs or videos, and a virtual reality (VR) box. It should be noted, that although the present application will routinely use the phrase “smart phone” that may include and device having the features of a camera, motion & elevation sensors, display, processor, and memory. One skilled in the art could substitute a tablet device, or specialized binocular camera that is specifically adapted to such applications.

Unlike most modern smart phones and smart phone add-ons the current device uses two, spaced, camera lenses alongside electronic sensors and other devices to make and record two photographic images simultaneously. This is a requirement for producing high quality 3D images, to be displayed on a motion picture screen, or in a VR headset.

In addition, most add-ons do not have the proper applications to process video taken simultaneously from two cameras. Often, it is preferable to simultaneously record, process, and store video or pictures taken by one or more cameras as this allows for software and hardware processing of the data. A software package is also used to re-constitute images for display of the video taken by the two cameras.

Third, the VR box is an innovation over previous modern devices. There are a variety of currently available, commercial VR boxes. However, the current application contemplates modifications made to accommodate the manipulation of the camera shutter button and a switch between the function of the smart phone as a camera and the alternative function as a viewer of stored digital data. This allows the user to quickly switch between actively recording in 3D and reviewing previously recorded material.

The advantages of such an application become clear when one is experienced in 3D recording and display. Typical devices currently on the market do not have the confluence and plethora of features contemplated and described herein.

A first embodiment of the invention contemplates a virtual reality apparatus comprising, a virtual reality box, the virtual reality box having a structure for holding a smart phone in a fixed position relative to a user's eyes, a cushioning structure for holding the virtual reality box tightly against the user's forehead, and strap for holding the virtual reality box in place; and the smartphone including one or more processors and a memory, and having front and a back, the front including a touch screen display, the back including a first camera lens and a second camera lens spaced apart from the first camera lens, and electronic sensing devices located on the back of the computing device in communication with the one or more processors and memory and receiving visual information that has passed through the first and second camera lenses.

A second embodiment of the invention contemplates a virtual reality apparatus comprising, a virtual reality box, the virtual reality box having a structure for holding a smart phone in a fixed position relative to a user's eyes, a cushioning structure for holding the virtual reality box tightly against the user's forehead, and strap for holding the virtual reality box in place; the smart phone including one or more processors and a memory, and having front and a back, the front including a touch screen display, the back including a first camera lens and a second camera lens spaced apart from the first camera lens, and electronic sensing devices for measuring the orientation of the device with respect to the azimuth and elevation angles of the smart phone, and means for communicating the visual, auditory and orientation data to the one or more processors and memory and receiving visual information that has passed through the first and second camera lenses; said memory containing programming to coordinate the placement of dual images produced by said first and second lenses in side by side juxtaposition on the screen of said smart phone, and placing the images in positions which relate to the direction of orientation of the user's head, so as to simulate the presence of the viewer in the scene being photographed or recorded, or having been previously photographed or recorded and stored in the memory.

In another preferred embodiment of the invention the disclosure contemplates A computing device, having a front and a back comprising a touch screen display located on the front of the computing device; one or more processors; memory; a first camera lens located on back of the computing device opposite the touch screen display; a second camera lens located on the back of the computing device, spaced apart from the first camera lens; electronic sensing devices located on the back of the computing device in communication with the one or more processors and memory and receiving visual information that has passed through the first and second camera lenses.

In another embodiment of the invention the disclosure contemplates, a computer-implemented method, comprising, at a computing device with a touch screen display and a first camera lens and a second camera lens, recording video simultaneously through the first camera lens and second camera lens; processing the recorded video into a processed video; and displaying the processed video on the touch screen display.

Such embodiments do not represent the full scope of the invention. Reference is made therefore to the claims herein for interpreting the full scope of the invention. Other objects of the present invention, as well as particular features, elements, and advantages thereof, will be elucidated or become apparent from, the following description and the accompanying drawing figures.

### DESCRIPTION OF THE DRAWINGS

The present invention may be better understood, and its numerous objects, features, and advantages made apparent to those skilled in the art by referencing the accompanying drawings.

FIG. 1a is back side view of a representative smart phone with a single camera.

FIG. 1b front screen view of a representative smart phone.

FIG. 1c is a back side view of a dual-lens smart phone according to the present disclosure.

FIG. 2 is a perspective view of a modified virtual reality box in cooperation with a modified dual-lens smart phone.

FIG. 3 is a depiction of the viewer's perspective of the scene a user sees when viewing the inside of the virtual reality box of FIG. 2.

FIG. 4 is a view of a representative scene being photographed by the smart phone mounted in the virtual reality box.

FIG. 5 is a view of what each eye sees when viewing the representative scene of FIG. 4 through the virtual reality box.

### DETAILED DESCRIPTION

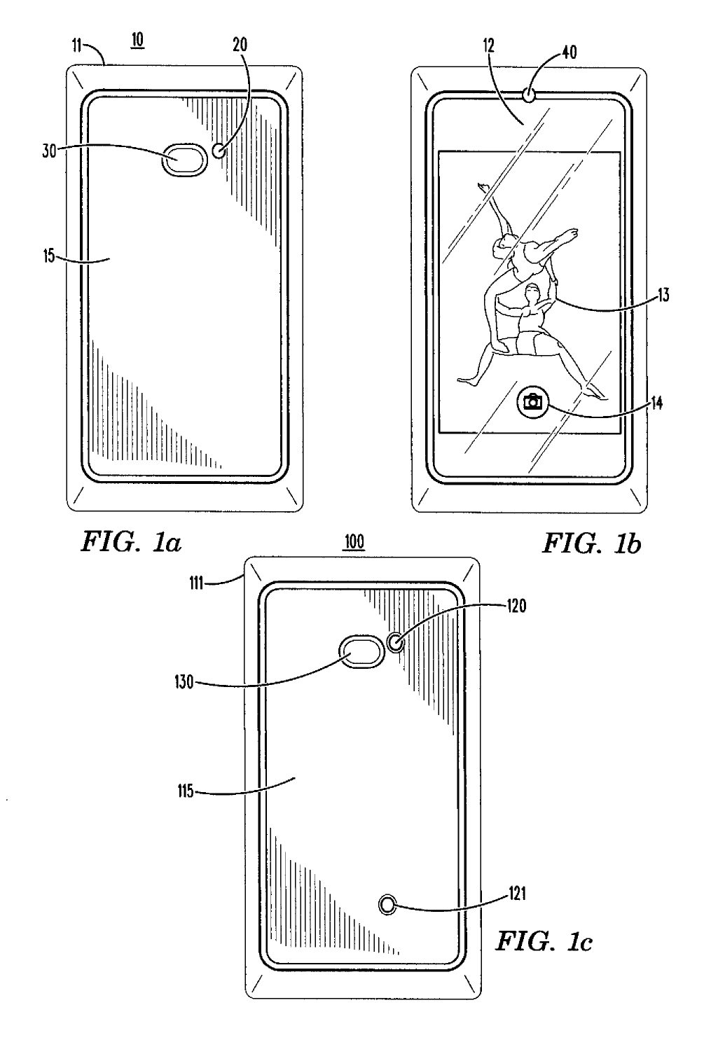

Referring now the drawings with more specificity, the present invention essentially provides a virtual reality recording and viewing system and apparatus including visual and auditory information. The preferred embodiments of the present invention will now be described with reference to FIGS. 1-5 of the drawings. Variations and embodiments contained herein will become apparent in light of the following descriptions.

Looking now to FIGS. 1a and 1b a traditional smart phone 10 having border 11 is shown. As noted above, smart phone 10 may be replaced with a tablet or other computer device having the features necessary. Such a device may be known as a “smart camera”, but all devices having such features are referred to as “smart phone” herein. As is known to those in the art a smart can be equipped with an assortment of one or more processors, memory, and other electronics. On Fig. la a representative backside 15 is shown. The traditional backside of a smart phone (as at 10) is equipped with a single camera 20 and may also have additional electronic equipment 30. Such equipment may be a lighting device, fingerprint reader, microphone, or any number of other utilities a smart phone user and manufacturer might incorporate. In FIG. 1b the front side of a traditional smart phone is shown. The front side of a smart phone will typically have a front screen 12, the front screen is typically a touch screen that displays images 13 and icons 14 that allow the user to interact with the smart phone 10. In most models of modern smart phones, the phone 10 is equipped with a front-facing or “selfie” camera 40. While the selfie camera is not necessary for use with the systems disclosed herein, it may be incorporated into such devices and apparatuses to improve the experience of the average user (who will not wish to lose “selfie” functionality.

FIG. 1c shows a modified smart phone 100 from the back 115 according to the present disclosure. It may be appreciated that such a back may have the same or similar features on the front side to those shown in FIG. 1b and other traditional smart phones. In the disclosure, border 111 can protect the phone from drops or other impacts. As can be seen, the device of FIG. 1c has two cameras, a first camera 120 and a second camera 121. The cameras consist of exterior lenses and interior electronic detection systems that can convey visual information to the smart phone's electronics. In most implementations, the camera lenses 120, 121, will be aligned parallel with the side of the smart phone and spaced apart from each other to approximate the normal spacing between human eyes (35-40 cm). In other implementations it is preferred to space the lenses 120, 121 apart by 90% the height of the phone. This may be smaller or larger than the traditional eye spacing, depending on the size of the smart phone. In still other implementations a value between those two extremes is chosen. It is traditionally thought to be optimal to select the human eye spacing (35-40 cm), but visual processing hardware and software can account for other spacings to give the illusion of optimal spacing, under certain conditions. Each lens 120, 121 in this enhanced smart phone 100 is designed to provide a wide viewing angle approaching 180 degrees horizontally and at least 90 degrees vertically. This camera setup enhances the three-dimensional images that are output onto the touch screen (as at 12) when viewed by a user. Just as in traditional devices the backside 115 of the smart phone 100 may also have peripheral electronics 130.

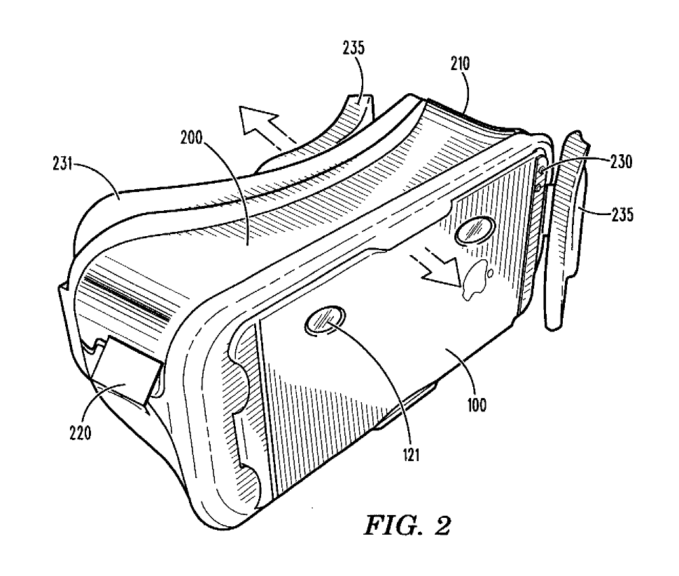

Looking now to FIG. 2, the modified smart phone 100 described herein is shown in conjunction with a specially designed virtual reality (VR) viewing box 200. As can be seen in FIG. 2, the back side of the smart phone 100 containing cameras 120 & 121 faces forwards and away from the viewer who is able to wear the smart phone 100 plus VR box 200 apparatus to film and watch three dimensional images simultaneously. The VR box, essentially is comprised of a mount for a smart phone, veil or shade 210 (for preventing outside light from interfering with the VR system), lenses inside the box (not shown in FIG. 2, described herein), cushioning structure 231 (for comfort and proper spacing of the touch screen from the viewer's eyes) and straps 232 or other securing devices for keeping the VR box 200 attached to the head of a user. in addition, the VR box can have flaps 230 and panels 235. Flaps 220 and panels 235 can be arranged such that it allows the user to operate certain functions on smart phone 100 while also wearing the VR box 200. This is essential when the user is simultaneously viewing and recording three dimensional images, as contemplated in this disclosure.

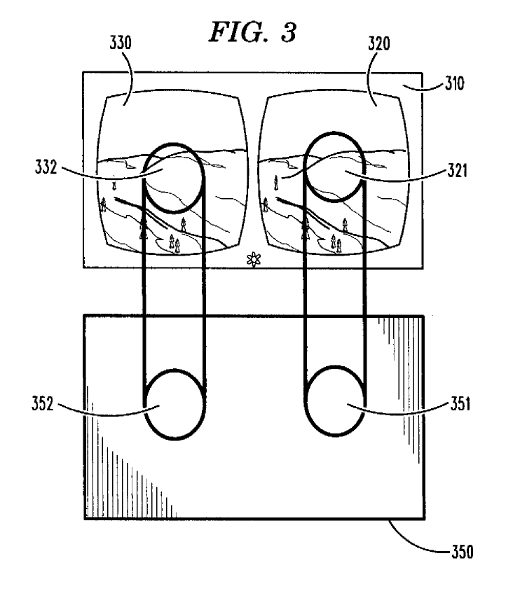

Now looking to FIG. 3, the functionalities of a viewing system utilizing smart phone 100 and VR box 200 are shown. The smart phone 100 will be equipped with an application program that brings about the display of each frame captured by the two lenses 120, 121 onto the single full display screen 310 as shown. Each of the two figures displayed 320, 330 occupies approximately one-half of the viewing area. These images travel through VR box lenses 321 & 332 to the viewer's eyes, each image then passes through a single eye 351, 352 and thus creates the impression of a three dimensional image in the viewer's brain. In addition, the phone 100 application should record data about the time, the azimuth & elevation angles of the phone corresponding to each frame of the video recording (using such instrumentation that is present in a typical smart phone).

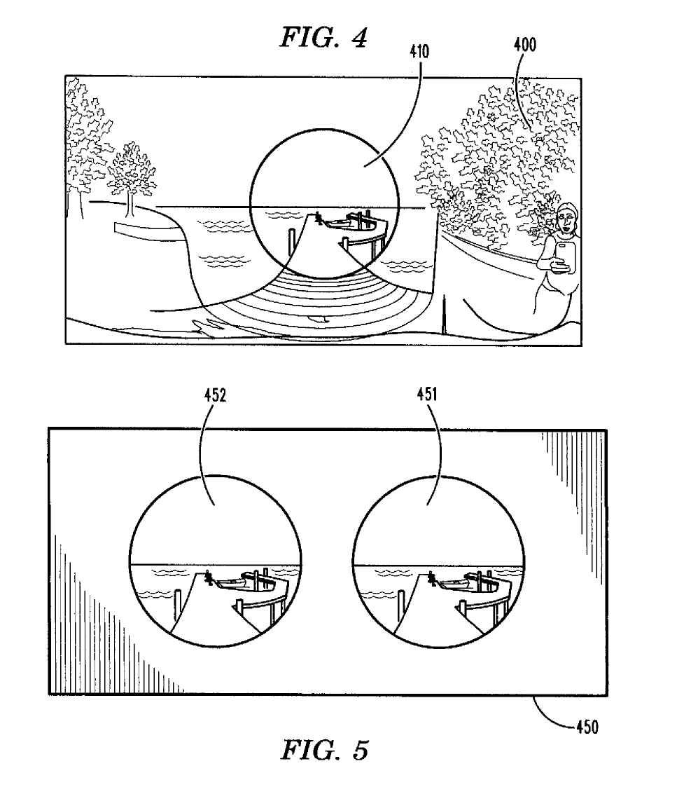

As Discussed above, and further explained in FIGS. 4 & 5 a three dimensional setting 400, as seen in FIG. 4 is recorded by cameras 120 & 121. However, only a small portion 410 of the setting is then selected by the smart phone 100 applications for display. Thus, as is shown in FIG. 5 the view 450 through VR Box 200 consists of a right-eye portion 451 and a left-eye portion 452. These are both two dimensional images, which the brain then translates into a three dimensional image, giving a user of the apparatus a feeling of virtual reality.

As should be clear to one of ordinary skill in the art, these elements properly arranged permit the user to wear the VR box 200 with the smart phone 100 mounted on it and see the outside world essentially as he/she would see it were he using his own eyes looking through binoculars. That is, the user would see a limited section 410 of the scene directly before him, but that section would be presented in photorealistic 3D. As is normal, for faraway objects, the perception of 3D would be limited as both views 451 & 452 would become more and more similar (just like when one looks at a faraway object from the top of a mountain). This should allow a user to wear the apparatus and perform most normal activities (so long as significant peripheral vision is not needed). It is important to note, however, that even though the wearer can only see a small portion of the view 410, the cameras 120, 121 have the ability to record the entire scene 400 (as described above). This means that the user can take a still photo, then change the headset to “view photo” mode and turn his head to see more of the world (like in certain other VR experiences). In addition, users can record “experiences” that can be saved and later viewed by the same user, or others who wish to share the experience. Because the application can record both the entire 180 degree view, as well as the tilt of the headset when the user was recording, each new pass through a video or view of a photograph can be a unique experience. Thus, with the modified smart phone 100, VR box 200 and software viewing application, a photographer could take pictures at his leisure, then review them in greater detail immediately, or any time thereafter.

Accordingly, although the invention has been described by reference to certain preferred and alternative embodiments, it is not intended that the novel arrangements be limited thereby, but that modifications thereof are intended to be included as falling within the broad scope and spirit of the foregoing disclosures and the appended drawings.

I claim:

1. A virtual reality apparatus comprising:
a virtual reality box, the virtual reality box having a structure for holding a smart phone in a fixed position relative to a user's eyes, a cushioning structure for holding the virtual reality box tightly against the user's forehead, and strap for holding the virtual reality box in place; and
the smart phone including one or more processors and a memory, and having front and a back, the front including a touch screen display, the back including a first camera lens and a second camera lens spaced apart from the first camera lens, and electronic sensing devices for measuring the orientation of the device with respect to the azimuth and elevation angles of the smart phone, and means for communicating the visual, auditory and orientation data to the one or more processors and memory and receiving visual information that has passed through the first and second camera lenses;
said memory containing programming to coordinate the placement of dual images produced by said first and second lenses in side by side juxtaposition on the screen of said smart phone, and placing the images in positions which relate to the direction of orientation of the user's head, so as to simulate the presence of the viewer in the scene being photographed or recorded, or having been previously photographed or recorded and stored in the memory.

2. The virtual reality apparatus of claim 1 wherein:
the structure for holding a smart phone has an opening for the first camera lens and an opening for the second camera lens, and an opening that enables the user to have an unobstructed view of the touch screen display.

3. The virtual reality apparatus of claim 2 wherein:
a side of the virtual reality box has an opening for pressing a button on the smart phone that will initiate and stop recording of video through the first and second camera lenses or the initiation of a still photograph.

4. The virtual reality apparatus of claim 3 wherein the virtual reality box further comprises:
a framework for holding two internal lenses near one or more sides of the virtual reality box, each internal lens focusing a portion of the touch screen display onto user's eyes, such that each eye perceives the same portion of two side by side displayed images produced by the first and second lenses, and displayed on the touch screen.

5. The virtual reality apparatus of claim 4 wherein:
the internal lenses are circular and magnify a portion of the screen, and limits the vision of each of the user's eyes to an appropriate side of the image displayed on the touch screen.

6. The virtual reality apparatus of claim 2 wherein the virtual reality box further comprises:
a rotatable flap for covering and uncovering a set of control functions that interact with the smart phone.

7. The computing device of claim 2 wherein:
the second camera lens is spaced apart from the first camera lens by a distance approximating the normal spacing between the human eyes.

8. The computing device of claim 7 further comprising:
one or more programs, wherein the one or more programs are stored in the memory and configured to be executed by the one or more processors, the one or more programs including:
instructions for recording video through the first camera lens and the second camera lens simultaneously;
instructions for commanding for the device be begin recording video; and
instructions for commanding for the device be stop recording video.

9. The computing device of claim 8 wherein the one or more programs further comprises:
instructions for displaying video on the touchscreen being recorded in real time.

10. The computing device of claim 9 wherein the one or more programs further comprises:
instructions for sensing an azimuth angle and an elevation angle of a centerline through a center of the device between the front and back of the device; and
instructions for adjusting the visual display on the touchscreen in real time in accordance with changes in the azimuth and elevation angles.

11. The computing device of claim 10 wherein the one or more programs further comprises:
instructions for playback of a video previously stored in the memory.

12. A computing device, having a front and a back comprising:
a touch screen display located on the front of the computing device;
one or more processors;
memory;
a first camera lens located on back of the computing device opposite the touch screen display;
a second camera lens located on the back of the computing device, spaced apart from the first camera lens;
electronic sensing devices located on the back of the computing device in communication with the one or more processors and memory and receiving visual information that has passed through the first and second camera lenses.

13. The computing device of claim 12 wherein:
the second camera lens is spaced apart from the first camera lens by a distance approximating the normal spacing between the human eyes.

14. The computing device of claim 13 further comprising:
one or more programs, wherein the one or more programs are stored in the memory and configured to be executed by the one or more processors, the one or more programs including:
instructions for recording video through the first camera lens and the second camera lens simultaneously;
instructions for commanding for the device be begin recording video; and
instructions for commanding for the device be stop recording video.

15. The computing device of claim 14 wherein the one or more programs further comprises:
instructions for displaying the camera view as seen by the first and second lenses, or the reorded video or still photographs, or on the touchscreen being recorded in real time.

16. The computing device of claim 15 wherein the one or more programs further comprises:
instructions for sensing an azimuth angle and an elevation angle of a centerline through a center of the device perpendicular to the front and back of the device; and
instructions for adjusting the visual display on the touchscreen in real time in accordance with changes in the azimuth and elevation angles.

17. The computing device of claim 16 wherein the one or more programs further comprises:
instructions for playback of a video previously stored in the memory.

18. A computer-implemented method, comprising:
at a computing device with a touch screen display and a first camera lens and a second camera lens,
recording video simultaneously through the first camera lens and second camera lens;
processing the recorded video into a processed video; and
displaying the processed video on the touch screen display.

19. The method of claim 18, further comprising:
storing the processed video in a memory and displaying the processed video on the touch screen display from the memory.
